(19) United States
(12) Patent Application Publication
(10) Pub. No.: US 2023/0196326 A1
(43) Pub. Date: Jun. 22, 2023

(54) SYSTEM AND METHOD FOR EMBEDDING INTERACTIVE EXPERIENCES ONTO PAYMENT CARDS

(71) Applicant: Percents, Inc. (dba Percents), Seattle, WA (US)

(72) Inventors: Benjamin Taylor, Seattle, WA (US); Phillip Chao, Seattle, WA (US)

(21) Appl. No.: 18/081,553

(22) Filed: Dec. 14, 2022

Related U.S. Application Data
(60) Provisional application No. 63/291,274, filed on Dec. 17, 2021.

(51) Int. Cl. G06Q 20/22; G06Q 20/10

(52) U.S. Cl. CPC G06Q 20/227; G06Q 20/102; G06Q 20/223

(57) ABSTRACT

A system for embedding interactive experiences onto a payment card and methods for making and utilizing the same. The system can include creating an embedded interactive experience on a payment device and performing an action relative to a payment device user and/or a payment associated with the payment device via the embedded interactive experience. In selected embodiments, the embedded interactive experience can be changed dynamically. The embedded interactive experience can be changed, for example, by the payment device user, by remote software commands or automatically based on information about the payment device user and recent purchases made via the payment device. Advantageously, the system can provide a process by which interactive experiences can be embedded into the payment device in a manner that can be controlled by an interface, such as a digital (i.e., mobile or web) interface presented via a mobile application or website.

### CROSS-REFERENCE TO RELATED APPLICATIONS

This application claims the benefit of, and priority to, U.S. Provisional Application Ser. No. 63/291,274, filed on Dec. 17, 2021, the disclosure of which is hereby incorporated herein by reference in its entirety and for all purposes.

### FIELD

The disclosed embodiments relate generally to the field of payment cards and more particularly, but not exclusively, to systems and methods for embedding interactive experiences onto payment cards.

### BACKGROUND

Instances often arise in which a user of a payment device (or another person relative to the user) would like to perform an action associated with the payment device or payment method relative to usage of the payment device for a purchase or perform an action relative to the user or the user's payment account(s) or payment method(s) associated with the payment device. These actions or interactions may vary drastically depending on the location and environment of the user, the most recent purchase of the user, and any recent interactions with recent payments, among other possibilities. Conventional payment devices, however, are unable to support such actions.

In view of the foregoing, a need exists for a system and method for embedding interactive experiences onto a payment devices that overcome the aforementioned obstacles and deficiencies of currently-available payment devices.

### BRIEF DESCRIPTION OF THE DRAWINGS

FIG. 1 is a top level flow chart illustrating an exemplary embodiment of a method for embedding interactive experiences onto a payment card, wherein the method includes creating an embedded interactive experience on a payment device and performing an action relative to a payment device user and/or a payment associated with the payment device via the embedded interactive experience.

FIG. 2A is a detail flow chart illustrating an exemplary embodiment of creating the embedded interactive experience on the payment device of the method of FIG. 1.

FIG. 2B is a detail flow chart illustrating an exemplary embodiment of performing the action relative to the payment device user and/or the payment associated with the payment device via the embedded interactive experience of the method of FIG. 1.

FIG. 3 shows an example computer, according to various embodiments.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

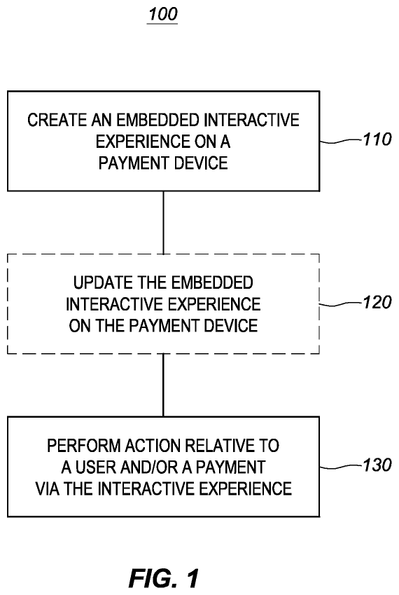

Since conventional payment devices do not support actions associated with the payment devices, actions associated with payment methods relative to usage of the payment devices or actions relative to payment device users or their payment accounts, a payment device system and method that can be changed dynamically by a payment device user, remote software commands and/or automatically can prove desirable and provide a basis for a wide range of applications, such as credit cards, debit cards and other types of payment devices. This result can be achieved, according to one embodiment disclosed herein, by a payment device method 100 as illustrated in FIG. 1.

Turning to FIG. 1, the payment device method 100 is shown as including, at 110, creating an embedded interactive experience on a payment device (not shown). Stated somewhat differently, the interactive experience can be embedded onto the payment device. The payment device can comprise any conventional type of payment device, such as a debit card, a credit card or other physical or virtual payment card. The payment device can be associated with one or more financial accounts and/or one or more device financial account owners or other payment device users.

The interactive experience of the payment device method 100 can be embedded onto the payment device, at 110, in any suitable manner. The payment device, for example, can be associated with a deep link Uniform Resource Locator (or URL) or other type of deep link for providing the embedded interactive experience. A link can be embedded on the payment device, for example, for accessing the deep link. When a selected payment device user makes a purchase or performs another type of financial transaction by way of the payment device, the deep link associated with the payment device can change based upon the financial transaction. In selected embodiments, the deep link associated with the payment device can be changed via a remote computer (or server) system (or circuit) (not shown). The remoter server system advantageously can change what that embedded link points to or does relative to financial transactions initiated by the payment device user.

Additionally and/or alternatively, the embedded interactive experience can comprise a link to one or more financial accounts and/or other information unrelated to the payment device associated with the payment device user. Exemplary financial accounts and/or other information unrelated to the payment device can include, but are not limited to, a personal social media account, a personal email address, a personal telephone number, a separate personal financial account associated with the payment device user. In selected embodiments, the financial accounts and/or other information unrelated to the payment device can include a business social media account, a business email address, a business telephone number and/or a separate business financial account associated with the payment device user without limitation. The financial accounts and/or other information unrelated to the payment device can be dynamically available or unavailable based upon one or more predetermined criteria. For example, the predetermined criteria can comprise, but is not limited to, a geographic location of the payment device user, a time of day, a day of the week, and/or one or more calendar events that the payment device user is scheduled to attend, among other possible factors.

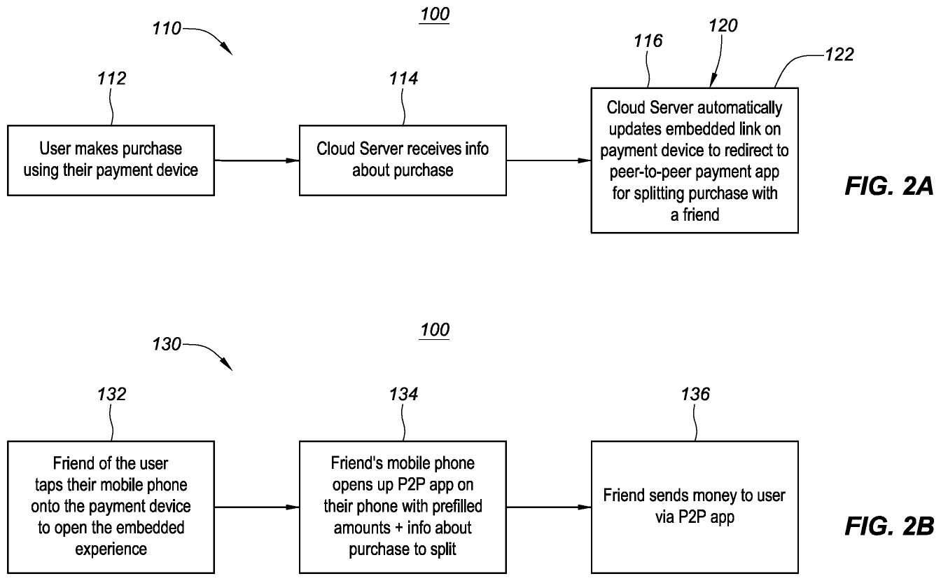

An exemplary manner for utilizing the embedded interactive experience is shown in FIG. 2A. Turning to FIG. 2A, a selected payment device user makes a purchase or performs another type of financial transaction, at 112, by way of the payment device. At 114, information about the purchase can be transmitted to, and/or received by, a remote computer system (or circuit). The remote computer system preferably comprises a server system, such as a Cloud server system.

Returning to FIG. 1, the embedded interactive experience on a payment device optionally can be updated or otherwise changed, at 120. The embedded interactive experience on the payment device can be changed in any suitable manner. For example, the embedded interactive experience on the payment device can be changed manually, such as by the payment device user, and/or automatically. In selected embodiments, automatic changes to the embedded interactive experience can be initiated by a financial transaction, such as a purchase, involving the payment device and/or on a periodic basis, such as weekly, monthly and/or annually. In other words, the interactive experiences embedded onto the payment device can be changed dynamically, either by the user, by remote software commands, or automatically based on variables about the payment device user and/or recent purchases or other financial transactions by the payment device user.

The embedded interactive experience on the payment device can be changed via the remote computer system as illustrated in FIG. 2A. The payment device method 100, for example, shows that the remote computer system can automatically update an embedded link on the payment device, at 122, to redirect to a peer-to-peer payment software application (or app) for splitting the cost of a recent purchase with a friend or other individual or third party associated with the payment device user.

Returning again to FIG. 1, the payment device method 100 is shown as including, at 130, performing an action relative to the payment device user. Exemplary actions can include, but are not limited to, a purchase, a payment and/or a credit. Additionally and/or alternatively, the payment device user can make a payment or performs another type of financial transaction by way of the payment device. The performed action and/or financial transaction can be performed via the interactive experience.

The performed action and/or financial transaction can be performed, at 130, in any suitable manner. An exemplary financial transaction is illustrated in FIG. 2B. Turning to FIG. 2B, the third party associated with the payment device user can access the interactive experience embedded on the payment device, at 132. The third party, for example, can possess a processing system (or circuit) (not shown) and utilize the processing system for opening the interactive experience embedded on the payment device. Exemplary processing systems associated with the third party can include, but are not limited to, a mobile (or smart) telephone device, a tablet device, laptop computer system, and/or a desktop computer system. In selected embodiments, the processing system of the third party can present an icon or other activatable indicia that can be tapped or otherwise activated by the third party to access the interactive experience embedded on the payment device.

At 134, the processing system of the third party can include a peer-to-peer (or P2P) payment system software application (or app). The P2P payment system app can enable the third party to transfer funds to the payment device user. When opened, the P2P payment system app can enable the third party to enter a transfer amount and/or a textual description or other information about the funds transfer. In selected embodiments, the transfer amount and/or other information about the funds transfer can be automatically filled by the P2P payment system app.

As shown in FIG. 2B, the funds transfer can comprise a reimbursement to be paid to the payment device user for a joint purchase in which the payment device user and the third party split the price in a predetermined manner. The P2P payment system app can enable the third party to transfer the entered transfer amount of the funds transfer to the payment device user, at 136.

Operation of the payment device method 100 can be illustrated via an exemplary embedded interactive experience scenario in which two friends go out to dinner at a restaurant. The first friend can possess a first payment device with an embedded interactive experience in accordance with the payment device method 100; whereas, the second friend can possess a second, conventional payment device. The first payment device preferably can be available from Percents, Inc., in Seattle, Wash.

At the end of the dinner, the first and second friends are presented with the bill for the dinner. The first friend can pay the full dinner bill amount via the first payment device. The first friend then can open a software application (or app) for enabling the first friend to split the cost of the dinner. In selected embodiments, the software application can include the above-referenced peer-to-peer payment software application (or app). Via the software application, the first user can select the transaction associated with the dinner bill and create a split of the transaction, updating the deep link embedded on the first payment device. The second friend, on the other hand, can possess smart telephone and can tap the smart telephone to the first payment device, prompting the smart telephone to open a bill splitting application (or app), such as Venmo available from Venmo, LLC, in New York, N.Y., and pay one half of the dinner bill amount with prefilled details about the restaurant.

Impressed with the experience, the second friend can ask the first friend about the first payment device and request a referral or more information about Percents, Inc. The first friend, in selected embodiments, can reopen a software application (or open a separate referral software application) for referring new device users to Percents, Inc. The software application can enable the first friend to select an option to refer the second friend to Percents, Inc., while updating the deep link on the first payment device. The second friend can again tap the smart telephone to the first payment device and thereby be prompted to open a webpage on the Percents, Inc., website to sign up with Percents, Inc.

The payment device method 100 advantageously can provide a process by which interactive experiences can be embedded into (and/or onto) the payment device in a manner that can be controlled by an interface. The interface can comprise a digital interface, such as a mobile interface and/or a web interface, and/or can be presented via a mobile software application or website.

In selected embodiments, the interface can enable the payment device user to make selections regarding the embedded interactive experience on the payment card. The payment device user, for example, can update the interactive digital experience to perform new functions and/or different functions. Additionally and/or alternatively, the payment device method 100 can utilize back-end software that optionally can operate in concert with a mobile application and other software services. The back-end software can automatically update the embedded interactive experience based on a context associated with the payment device user. Exemplary contact information associated with the payment device user can include a geographic (or physical) location of the payment device, a spending history on the payment device by the payment device user, and/or one or more other situational changes associated with the payment device user, without limitation.

The interactive experience embedded on the payment device can involve a variety of different services and actions. Thereby, the embedded interactive experience can enable the payment device user to perform one or more novel functions and other uses.

In selected embodiments, the embedded interactive experience can include a redirect to a peer-to-peer payment app for a third party or other person to send money to the payment device user. The money transfer can include details about the transfer (amount, merchant info, description) and can be embedded into the redirect from the payment device.

Additionally and/or alternatively, the embedded interactive experience can comprise a link to a referral to an embedded interactive experience service or another service for one or more other individuals who are referred by the payment device user. In selected embodiments, the referral can include one or more user-specific referral codes or other indicia that can track the sign-up from this referral and offer additional sign-up rewards to the individuals interacting with the payment device associated with the payment device user.

The embedded interactive experience optionally can be embodied by a deep link to one of software services offered or otherwise provided to payment device users. The software services advantageously can enable the payment device users to make a change to the embedded experience via their respective digital interfaces and/or to have the embedded experience be automatically updated without requiring the payment device users to manually update the embedded experience on the payment device themselves, such in a non-digital manner.

In selected embodiments, a selected payment device user can update the embedded interactive experience via a user processing system (or circuit) associated with the selected payment device user. If the user processing system comprises a mobile user processing system, such as a mobile (or smart) telephone device, the selected payment device user can update the embedded interactive experience, for example, by reprogramming an embedded near field communication (or NFC) tag (or chip) system (or circuit).

Additionally and/or alternatively, the embedded interactive experience can be embedded into the payment device via a digital-to-physical interface system (or circuit). The digital-to-physical interface system can comprise any suitable type of digital-to-physical interface system. For example, the digital-to-physical interface system can include an embedded near field communication (or NFC) tag (or chip) system for redirecting a mobile processing system, such as a mobile (or smart) telephone device, to a Uniform Resource Locator (or URL) or a digital application when the mobile processing system is within range of the NFC tag system.

According to various embodiments, various functionality discussed herein can be performed by and/or with the help of one or more computers. Such a computer can be and/or incorporate, as just some examples, a personal computer, a server, a smartphone, a system-on-a-chip, and/or a microcontroller. Such a computer can, in various embodiments, run Linux, MacOS, Windows, or another operating system.

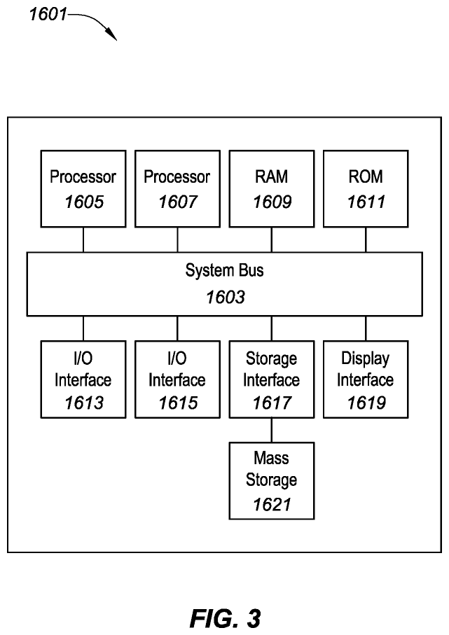

Such a computer can also be and/or incorporate one or more processors operatively connected to one or more memory or storage units, wherein the memory or storage may contain data, algorithms, and/or program code, and the processor or processors may execute the program code and/or manipulate the program code, data, and/or algorithms. Shown in FIG. 3 is an example computer employable in various embodiments of the present invention. Exemplary computer 1601 includes system bus 1603 which operatively connects two processors 1605 and 1607, random access memory (RAM) 1609, read-only memory (ROM) 1611, input and/or output (I/O) interfaces 1613 and 1615, storage interface 1617, and display interface 1619.

Storage interface 1617 in turn connects to mass storage 1621. Each of I/O interfaces 1613 and 1615 can, as just some examples, be a Universal Serial Bus (USB), a Thunderbolt, an Ethernet, a Bluetooth, a Long Term Evolution (LTE), a 5G, an IEEE 488, and/or other interface. Mass storage 1621 can be a flash drive, a hard drive, an optical drive, or a memory chip, as just some possibilities. Processors 1605 and 1607 can each be, as just some examples, a commonly known processor such as an ARM-based or x86-based processor.

Computer 1601 can, in various embodiments, include or be connected to a touch screen, a mouse, and/or a keyboard. Computer 1601 can additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules can, for example, be programmed using Python, Java, JavaScript, Swift, React, C, C++, C#, and/or another language. Corresponding program code can be placed on media such as, for example, DVD, CD-ROM, memory card, and/or floppy disk. It is noted that any indicated division of operations among particular software modules is for purposes of illustration, and that alternate divisions of operation may be employed.

Accordingly, any operations indicated as being performed by one software module can instead be performed by a plurality of software modules. Similarly, any operations indicated as being performed by a plurality of modules can instead be performed by a single module. It is noted that operations indicated as being performed by a particular computer can instead be performed by a plurality of computers. It is further noted that, in various embodiments, peer-to-peer and/or grid computing techniques may be employed.

It is additionally noted that, in various embodiments, remote communication among software modules may occur. Such remote communication can, for example, involve JavaScript Object Notation-Remote Procedure Call (JSON-RPC), Simple Object Access Protocol (SOAP), Java Messaging Service (JMS), Remote Method Invocation (RMI), Remote Procedure Call (RPC), sockets, and/or pipes.

Moreover, in various embodiments the functionality discussed herein can be implemented using special-purpose circuitry, such as via one or more integrated circuits, Application Specific Integrated Circuits (ASICs), or Field Programmable Gate Arrays (FPGAs). A Hardware Description Language (HDL) can, in various embodiments, be employed in instantiating the functionality discussed herein. Such an HDL can, as just some examples, be Verilog or Very High Speed Integrated Circuit Hardware Description Language (VHDL). More generally, various embodiments can be implemented using hardwired circuitry without or without software instructions. As such, the functionality discussed herein is limited neither to any specific combination of hardware circuitry and software, nor to any particular source for the instructions executed by the data processing system.

In selected embodiments, one or more of the features disclosed herein can be provided as a computer program product. The computer program product, for example, can be encoded on one or more non-transitory machine-readable storage media, such as magnetic, optical and/or electronic storage media of any kind and without limitation. As used herein, a phrase in the form of at least one of A, B, C and D herein is to be construed as meaning one or more of A, one or more of B, one or more of C and/or one or more of D. Likewise, a phrase in the form of A, B, C or D as used herein is to be construed as meaning A or B or C or D. For example, a phrase in the form of A, B, C or a combination thereof is to be construed as meaning A or B or C or any combination of A, B and/or C.

The disclosed embodiments are susceptible to various modifications and alternative forms, and specific examples thereof have been shown by way of example in the drawings and are herein described in detail. It should be understood, however, that the disclosed embodiments are not to be limited to the particular forms or methods disclosed, but to the contrary, the disclosed embodiments are to cover all modifications, equivalents, and alternatives.

What is claimed is:

1. A computer-implemented method for embedding an interactive experience onto a payment device associated with one or more financial accounts and one or more payment device users, comprising:
accessing the interactive experience via a deep link associated with the payment device via a processing circuit;
enabling an action to be initiated via the payment device;
enabling the initiated action to be conducted with at least one selected financial account associated with the payment device via the accessed interactive experience; and
updating the accessed interactive experience based upon the performed action via the processing circuit.

2. The method of claim 1, wherein said accessing the interactive experience includes accessing the interactive experience via a deep link Uniform Resource Locator with the payment device for creating the interactive experience on the payment device.

3. The method of claim 1, further comprising enabling at least one of the payment device users to control the interactive experience via a digital interface circuit.

4. The method of claim 1, further comprising enabling the interactive experience to be changed via at least one of the payment device users or via at least one software command executed by the processing circuit.

5. The method of claim 4, wherein said enabling the interactive experience to be changed comprises enabling the interactive experience to be dynamically changed.

6. The method of claim 4, wherein said enabling the interactive experience to be changed includes enabling the interactive experience to be automatically changed based upon a geographical location of the at least one of the payment device users, an environment of the at least one of the payment device users, a purchase made the at least one of the payment device users, or a payment made by the at least one of the payment device users.

7. The method of claim 1, wherein said enabling the action comprises enabling a financial transaction to be initiated via the payment device and conducted via the at least one selected financial account.

8. The method of claim 7, wherein said enabling the financial transaction includes enabling a purchase to be initiated via the payment device with a purchase price amount to be debited from the selected financial account, enabling a payment to be initiated via the payment device with a payment amount to be debited from the selected financial account or enabling a credit to be initiated via the payment device with a credit amount to be credited to the selected financial account.

9. The method of claim 7, wherein said enabling the financial transaction includes updating the deep link to redirect the financial transaction to a software application.

10. The method of claim 9, wherein said enabling the financial transaction includes updating the deep link to redirect the financial transaction to a peer-to-peer payment software application.

11. The method of claim 10, wherein the initiated financial transaction is conducted by dividing a monetary value associated with the financial transaction between a selected payment device user and a third party and initiating a transfer of a predetermined monetary amount from the third party to at least one of the financial accounts associated with the payment device via the peer-to-peer payment software application.

12. The method of claim 11, wherein said initiating the transfer includes opening the embedded experience via an interaction between the payment device and a mobile processing system associated with the third party and opening the peer-to-peer payment software application with prefilled information regarding the divided monetary value associated with the financial transaction on the mobile processing system associated with the third party.

13. The method of claim 12, wherein the interaction between the payment device and the mobile processing system associated with the third party comprises tapping the mobile processing system associated with the third party onto the payment device.

14. The method of claim 1, further comprising associating the deep link with a selected financial account or other information associated with a selected payment device user, wherein the selected financial account or other information is not associated with the payment device and is dynamically available based upon one or more predetermined criteria.

15. A computer program product for embedding an interactive experience onto a payment device associated with one or more financial accounts and one or more payment device users, the computer program product being encoded on one or more non-transitory machine-readable storage media and comprising:
instruction for associating a deep link with the payment device for creating the interactive experience on the payment device via a processing circuit;
instruction for enabling a financial transaction to be initiated via the payment device;
instruction for conducting the initiated financial transaction via at least one selected financial account associated with the payment device via the interactive experience; and
instruction for updating the interactive experience based upon the initiated financial transaction via the processing circuit.

16. A system for embedding an interactive experience, comprising:
at least one processing circuit being configured for accessing the interactive experience via a deep link associated with a payment device being associated with one or more financial accounts and one or more payment device users, enabling a financial transaction to be initiated via the payment device, enabling the initiated financial transaction to be conducted with at least one selected financial account associated with the payment device via the accessed interactive experience, and updating the accessed interactive experience based upon the performed financial transaction,
wherein the interactive experience is controlled via a digital interface associated with a mobile software application or a website.

17. The system of claim 16, wherein the payment device comprises a physical payment card.

18. The system of claim 17, wherein the physical payment card includes an embedded near field communication circuit for redirecting a mobile processing system of a selected payment device user to a digital application for updating the interactive experience when the mobile processing system is within range of the embedded near field communication circuit.

19. The system of claim 18, wherein the mobile processing system comprises a mobile telephone device, a smart telephone device, a tablet device, a laptop computer system, or a desktop computer system of the selected payment device user.

20. The system of claim 16, wherein the payment device comprises a virtual payment card.
